(19) United States
(12) Patent Application Publication
(10) Pub. No.: US 2004/0121298 A1
(43) Pub. Date: Jun. 24, 2004

(54) System and method of capturing and processing hand-written responses in the administration of assessments

(75) Inventors: Roger Packard Creamer, Pacific Grove, CA (US); David Michael Taggart, Monterey, CA (US)

Correspondence Address: ROTHWELL, FIGG, ERNST & MANBECK, P.C., 1425 K STREET, N.W., SUITE 800, WASHINGTON, DC, 20005, US

(73) Assignee: CTB/McGraw-Hill, Monterey, CA

(21) Appl. No.: 10/701,434

(22) Filed: Nov. 6, 2003

Related U.S. Application Data
(60) Provisional application No. 60/424,006, filed on Nov. 6, 2002.

(51) Int. Cl. G09B 19/00; G09B 7/00

(52) U.S. Cl. 434/322; 434/155; 345/179

(57) ABSTRACT

The present invention provides a system and methodology for overcoming the shortcomings of traditional pen and paper assessment administration while taking advantage of the benefits offered by computer technology in a manner that is fair to all respondents, regardless of their individual computer proficiencies. Hand written item responses are made by a writing instrument that creates a digital electronic record of the hand written response. The digital electronic record can then be stored, transmitted electronically, and evaluated.

### CROSS-REFERENCE OF RELATED APPLICATION

This application claims the benefit under 35 U.S.C. § 119(e) of the filing date of provisional patent application Serial No. 60/424,006 filed Nov. 6, 2002, which is incorporated herein by reference.

### BACKGROUND OF THE INVENTION

1. Field of the Invention

The present invention relates, generally, to a system for and methodology of capturing and processing (i.e., recording, collecting, reporting, etc.) hand-written responses in the administration of assessments and, more particularly, to a system and method implementing a recording device for capturing and processing hand-written constructed or selected responses to a response item on an educational assessment. While the primary application of the invention is for educational assessments, it may be applied to other fields including other assessments and surveys.

b 2. Description of the Background Art

Assessments are generally reproduced on paper in test books. Respondents or test takers generally record their answer choices on printed paper response sheets using a conventional pen or pencil. Response sheets can either be the original test books or separate answer sheets. In some instances, the answer choices are recorded by a proxy, such as a teacher or teacher's aide recording answers for a handicapped student. In other instances, item response information is recorded by an observer, such as a teacher observing a kindergarten student's identification of item responses; additionally, the observer or proxy may enter scores or observations or comments or demographic data or other identifying data relative to the respondent on the response sheet. In order to report (e.g., score and analyze) the information recorded on the printed paper, an administrator must manually collect and score response sheets. Electronically scoring of the response sheets requires that the response sheets be optically scanned and electronically stored in a digital format. Even electronic storage of the response requires manual collection of the sheets, transportation of the sheets to a location at which they can be scanned, and physical placement of the sheets on a scanning device. Thus, administration of assessments using paper response forms requires extensive manual processing and physical handling of the paper response sheets. Manual processing of response forms can constitute a large component of the cost of administration. In addition, manual processing creates a delay between a respondent's completion of the form and reporting of results and also creates opportunities for error due to mishandling of the paper forms.

Moreover, it is difficult or impossible to determine from a paper response sheet the response time to each item (i.e., a test question) on an assessment. Further, if more than one response is made to a multiple choice item, it is difficult to determine which response was last made, which presumably represents a respondent's final answer choice. It is conventionally assumed that a multiple choice response that is significantly darker than other marked responses is the final answer choice. While generally reliable, this requires a respondent to follow defined erasure and marking procedures, which can be error-prone.

Educational assessments administered by computer eliminate the above problems associated with traditional paper media; however, other problems may exist. For example, many types of educational assessment items require a constructed response, which presents a challenge for computerized administration of such items. Constructed response items are distinguished from selected or restricted response items in which one or more complete responses to the item are provided. In the restricted response, the respondent is requested to select the correct response(s), indicate whether a statement is true or false, or indicate agreement or disagreement with a statement. Examples of selected or restricted response items include multiple choice, true/false, or yes/no items.

A constructed response item refers to an item for which the respondent must form the response from elements created by and/or provided to the respondent. Constructed responses may include short answers of one or more words, essays, mathematical calculations or proofs, arrangements of graphical elements, architectural or mechanical drawings, musical scores, or logic operations. Thus, a constructed response may include one or more of letters, punctuation marks, numbers, drawings, graphical symbols or signs, grammatical operators, music notation, mathematical operators, logic operators or other written elements created by or provided to the respondent.

Responding to a constructed response item using traditional keyboard and/or mouse input devices may not be easy or intuitive for all respondents. Using these input devices, for example, to enter drawing or graphical responses, or responses to a mathematical item that requires expression of mathematical or algebraic symbology and symbol alignment can be extremely awkward. Moreover, respondents with experience using these input devices may gain an unfair advantage over those without such experience. As a result, scores produced from computer-based educational assessments (also referred to as on-line assessments) may become less accurate. Nevertheless, item responses that are collected with traditional educational assessments reproduced on paper (with responses recorded using conventional writing or marking instruments) may not produce results that are as accurate as item responses that are collected with on-line educational assessments.

U.S. Pat. No. 6,146,148, the disclosure of which is incorporated herein by reference, describes an automated testing and electronic instructional delivery system. The system includes student computer stations interconnected with a teacher computer station so that the teacher can monitor the activities and progress of each student at a student computer station as well as receive information from and send information to each student. Working at the student computer station, each student completes manual exercises in that student's student work book, which is presented on the student computer station monitor screen. Student handwritten responses are electronically recorded at the student computer station using an electronic pen tablet, such as a light pen, an electromagnetic or electrostatic pen-based status, or a touch sensitive computer screen. The use of these types of input devices is not as intuitive to the student as are conventional pens, pencils, or markers, especially for preparing constructed responses of some length, for example essays or mathematical computations or proofs. Thus, while the system described in the '148 patent provides an electronic record of the student's response, it does so at the cost of requiring the student to enter the response in a manner with which all students will not have comparable levels of comfort and proficiency.

Accordingly, there remains a need for a system and methodology for overcoming the shortcomings of traditional pen and paper assessment administration while taking advantage of the benefits offered by computer technology in a manner that is fair to all respondents, regardless of their individual computer proficiencies.

### SUMMARY OF THE INVENTION

The present invention is provided to solve the above-mentioned problems. An aspect of the invention is embodied in a method of administering a form requiring a hand-written response by a respondent, proxy, or observer. In order to simplify the presentation, the invention is expressed in terms of a respondent, but the invention applies equally well to any person recording the answers or other data pertinent to the respondent.

The method includes presenting to the respondent a stimulus requesting a hand-written constructive response by the respondent, electronically recording the hand-written constructed response to the stimulus to create recorded electronic data representative of the hand-written response, and analyzing the recorded electronic data to evaluate the hand-written response to the stimulus.

Another aspect of the invention is embodied in the same method which also includes presenting to the respondent a stimulus requesting a hand-written selection of a closed-ended response by the respondent, electronically recording the hand-written selection to the stimulus to create recorded electronic data representative of the hand-written selection, and analyzing the recorded electronic data to evaluate the hand-written response to the stimulus.

Another aspect of the invention is embodied in a system of administering a form requiring a hand-written response by a respondent. The system includes a stimulus to be presented to a respondent. The stimulus requests a hand-written constructed response by the respondent. Also included is a recording device adapted to electronically record the hand-written constructed response of the respondent to the stimulus to create recorded electronic data representative of the hand-written response, and a response analysis system adapted to facilitate the analysis of the recorded electronic data to evaluate the hand-written response to the stimulus.

Another aspect of the invention is embodied in the same system which also includes a stimulus to be presented to a respondent wherein the stimulus requests a hand-written selection of a response by the respondent. The recording device is also adapted to electronically record the hand-written selection of the respondent to the stimulus to create recorded electronic data representative of the hand-written selection, and the response analysis system is further adapted to facilitate the analysis of the recorded electronic data to evaluate the hand-written selection to the stimulus.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a functional block diagram of the architecture for a system for capturing and processing hand-written responses in the administration of educational assessments according to the present invention.

FIG. 2 is a flow diagram illustrating a system for and methodology of capturing and processing hand-written responses in the administration of educational assessments according to a first exemplary embodiment of the present invention.

FIG. 3 is a flow diagram illustrating a system for and methodology of capturing and processing hand-written responses in the administration of educational assessments according to a second exemplary embodiment of the present invention.

FIG. 4 is a flow diagram illustrating a system for and methodology of capturing and processing hand-written responses in the administration of educational assessments according to a third exemplary embodiment of the present invention.

### DETAILED DESCRIPTION OF THE EXEMPLARY EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, enterprise technologies, middleware, development interfaces, hardware, etc. in order to provide a thorough understanding of the present invention. However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, enterprise applications, operating systems, enterprise technologies, middleware, development interfaces, and hardware are omitted so as not to obscure the description of the present invention.

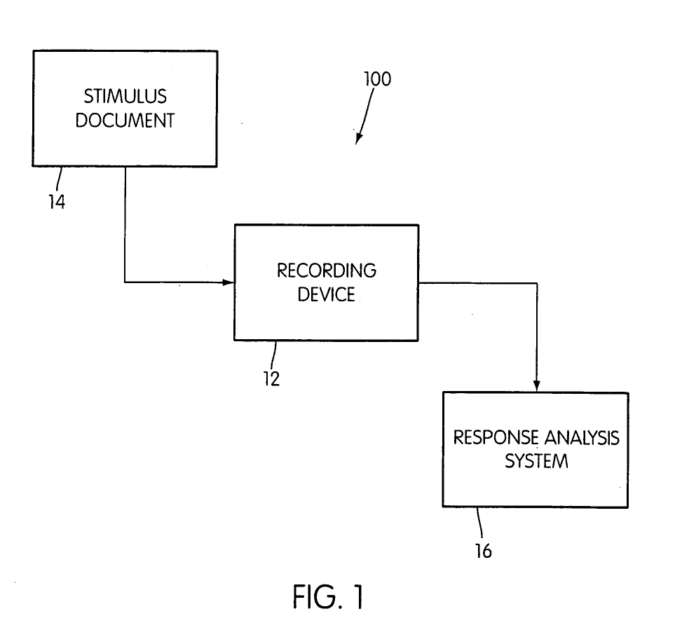

FIG. 1 is a functional block diagram of the architecture for a system for capturing and processing hand-written responses in the administration of educational assessments according to an exemplary embodiment of the present invention. Hand-written responses may include letters, punctuation marks, numbers, drawings, graphic symbols and signs, music notation, grammatical operators, mathematical operators, logic operators, or the like. A system 100 includes a recording device 12, a stimulus document 14, and a response analysis system 16. According to the invention, the stimulus document 14 presents a stimulus (e.g., an assessment item) requiring a handwritten response by the respondent, and the recording device 12 creates an electronic data record of the handwritten response that is transmitted to the response analysis system 16, for, e.g., scoring, tabulating, or otherwise analyzing the response.

Referring to FIG. 1, the recording device 12 may include a processor with associated software, a memory, a transceiver, a camera, a power source, a display screen, etc. The recording device 12 may be any device that allows the respondent to create a handwritten item response in a manner that generates a written record of the response on a writing surface (for example, a written ink record on paper) and also electronically captures and records the respondent's hand-written response to the stimulus. Suitable recording devices include a digitally recording writing instrument, a digital tablet, a portable digital notepad, a personal digital assistant (PDA) with a stylus or touch sensitive screen, a personal computer, a personal computer with a touch sensitive screen, or the like.

In the exemplary embodiment, the recording device 12 is a digitally recording writing instrument which provides a pen-like functionality allowing the respondent to form a “pen-to-paper” response to a response item in a fairly conventional manner while also creating an electronic record of the respondent's response. The recording device 12 electronically records hand printing, hand drawing, hand sketches, or the like to create recorded electronic data representative of marks made by the respondent on the writing surface using the writing functionality of the digitally recording writing instrument. The digitally recording writing instrument 12 can be wireless enabled to provide a real-time wireless connection between the writing instrument and a wireless hub or card. Alternatively, the writing instrument can be used free-standing with all writing activity captured into its internal memory and later downloaded in a complementary docking device. The data in the memory can be downloaded to an attached computer when placed into an inkwell-like docking device. Further, the writing instrument can be USB-attached or otherwise wired to a computer at all times (tethered), such that an independent memory or a battery is not required. As the writing instrument 12 is used, pen stroke information is sent in real time to the computer. It will be appreciated by those skilled in the art that other communicating connections may be implemented in the present invention.

A suitable digitally recording writing instrument and associated encoded grid pattern have been developed by Anoto AB of Sweden, and are described in numerous patent publications, including WO 01/16691, WO 01/16872, WO 01/26032, WO 01/26033, WO 01/26034, WO 01/48590, WO 01/48678, WO 01/61455, WO 01/71473, WO 01/71474, WO 01/71476, WO 01/71643, WO 01/71651, WO 01/71654, WO 01/74598, WO 01/75773, WO 01/75780, WO 01/75781, WO 01/95091, WO 01/95559, WO 02/19260, WO 02/39378, and WO 02/47021, the respective disclosures of which are hereby incorporated by reference. A version of the digitally recording writing instrument developed by Anoto AB is commercially available from Logitech® under the name io Personal Digital Pen.

In the Anoto system, an optically-readable position coding pattern, which is invisible to the human eye, is formed on the writing surface using standard offset printing techniques and ordinary carbon-based ink or any other infra-red absorbing ink. The position coding pattern uniquely identifies positional coordinates on the writing surface. A writing instrument has attached thereto or integrally assembled therewith a sensing device for electronic recording of what is being written or drawn with the writing instrument. The sensing device includes optics, electronic circuitry, and power supply components. Using the optics components, the circuitry reads images, e.g., generally at a frequency of 60 to 100 images per second, determines the position coding pattern in each image, and determines the positional coordinates corresponding to the pattern. Accordingly, the sensing device can determine where the writing instrument is on the writing surface and what is being written.

Other digital recording writing systems in which a detector mounted on a writing instrument determines and records the position of the instrument by sensing a position-coded pattern formed on the writing surface are described in U.S. Pat. No. 5,852,434 and U.S. Pat. No. 5,477,012, the disclosures of which are incorporated herein by reference.

Other digitally recording writing instruments include accelerometer pens based on inertial system navigation for providing real-time digital signals representative of the movement of the writing instrument. The movement information (e.g., pen position signals) are transmitted to a computer or other recording/translation system, and converted to signals representative of a user's response. An example of such an inertial-based digitally recording writing instrument is Microsoft's SmartQuill.

E-pen from InMotion is another digitally recording writing instrument. This writing instrument uses infrared and ultrasonic transponders for communicating with a small receiver provided on a user's document to capture the movements of the writing instrument. The signals representative of the writing instrument's movements are recorded and translated into the text of the user's response. The E-pen is described in further detail in U.S. Pat. Nos. 5,517,579 and 5,977,958, the respective disclosures of which are hereby incorporated by reference.

N-scribe from Digital Ink is yet another digitally recording writing instrument. This writing instrument emits infrared signals that are captured by and temporarily stored in a receiver clipped to a user's document for recording the writing instrument's motions, which can be translated into the text of the user's response. The stored signals can be later downloaded into a device for translation and permanent storage.

Another digitally recording writing instrument is commercially available under the name Vpen from OTM Technologies. The Vpen converts writing to ASCII text using pressure sensors and laser diffraction, which detects the writing instrument's motion, and sends the ASCII text to another device such as a handset.

The stimulus document 14 may be an educational assessment book or answer sheet that is in print media, an electronic format, or the like. When supported by the digital recording device, the educational assessment books or answer sheets can be produced with a section of the document containing a unique pattern which is detectable by the response analysis system 16. The unique pattern identifies each specific page of each document type. The document may be configured to identify, via a related database or data file, the specific respondent to whom the document has been assigned. For assessments supported by an Anoto-style pen and paper, some portion of the document that will be written on by the digitally recording writing instrument is printed with a grid pattern unique to each document instance. For other digital recording devices, alternative methods must be used to identify each page or each item on the page to which a response is recorded. Human readable information, such as the respondent's name, can be printed on the stimulus document 14 to help ensure that the correct respondent uses the correct document.

The response analysis system 16 may include a processor with associated software, a database or data file, a printer, a handwriting recognition system, and a scanner. The analysis system 16 processes the captured hand-written data, for example, performs data analysis, and generates reports based on item responses.

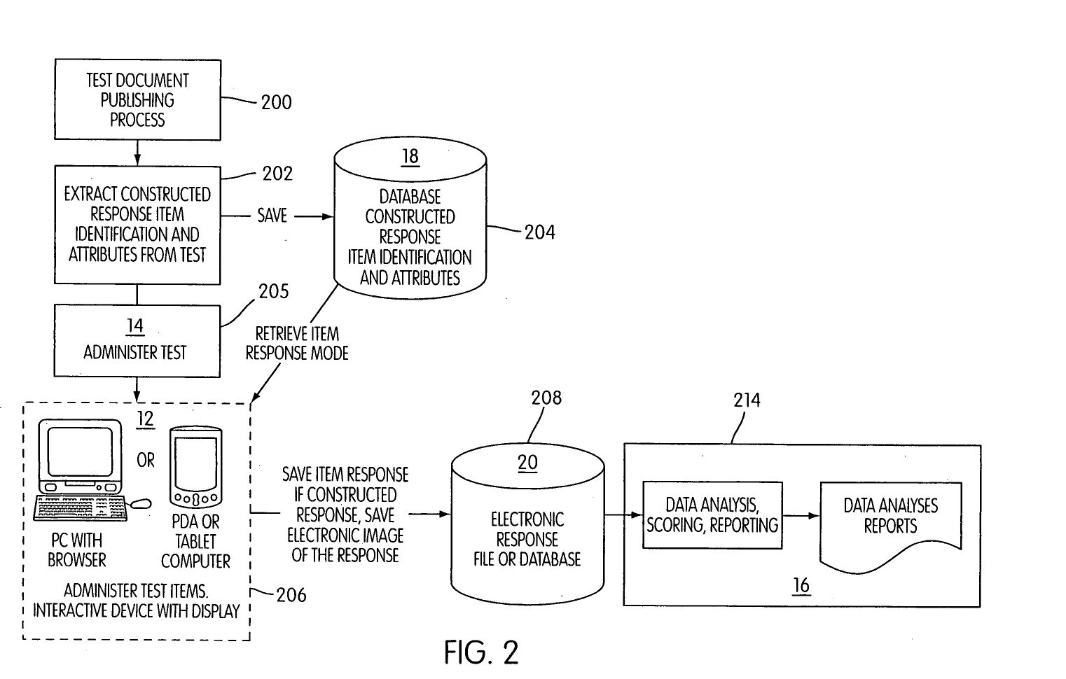

In an embodiment of the system for capturing and processing hand-written responses in the administration of educational assessments, the recording device 12 is a digital tablet or PDA with a stylus or touch screen input, or a PC with a touch sensitive screen (primary device). The operation of the system will now be explained with reference to FIG. 2. FIG. 2 is a flow diagram illustrating a system for and methodology of capturing and processing hand-written responses in the administration of educational assessments according to a first exemplary embodiment of the present invention.

An assessment document 14, in step 200, is processed by a document processing system, and a set of composed page electronic files defining the appearance of each printed page that is included in the assessment document 14 is produced. Response items requiring a constructed response are identified and extracted from the electronic files (step 202) by a constructed response extraction system. This information is stored in a database, data file or attribute field associated with the item content (step 204), and the recording device 12, e.g., stylus or touch screen of the PDA or PC, respectively, is enabled. The educational assessment is then administered on the recording device 12 by an item administration system in steps 205-206. As each constructed response item is presented, the recording device 12 is capable of capturing the response in natural hand writing, hand printing, hand drawing, hand sketches or the like, without requiring use of keyboard and/or mouse input devices, or in the alternative, keyboard and/or mouse input devices may be used for item types where they might be appropriate (e.g., text input). Multiple choice response items can also be captured with the recording device 12, e.g., stylus or touch screen input, or in the alternative, they can be selected using keyboard and/or mouse input devices, if available.

As the respondent responds to the constructed response items, the display screen of the recording device 12 may provide a real time display of the response content as it is being made. A digital representation of the response is then stored in a data file or database 20 in step 208. The response analysis system 16 analyzes, scores, and reports the stored data in step 214. It will be appreciated by those skilled in the art that the digital representation of the response can be analyzed, scored, and reported prior to or after being stored in the data file or database.

In a second exemplary embodiment of the present invention, the recording device 12 is an auxiliary device used in addition to a primary device. Alternatively, the primary device is augmented with an auxiliary device that can directly capture natural hand writing, hand print, hand drawing, hand sketches, or the like. The primary device is generally limited to keyboard and/or mouse devices for input. The auxiliary device can be a digitally recording writing instrument device, a digital tablet or PDA with a stylus or touch screen input, etc. The auxiliary device can be used to respond to constructed response items administered in an assessment. The auxiliary device is not limited to only constructed response items, and can be used to respond to selected response items as well.

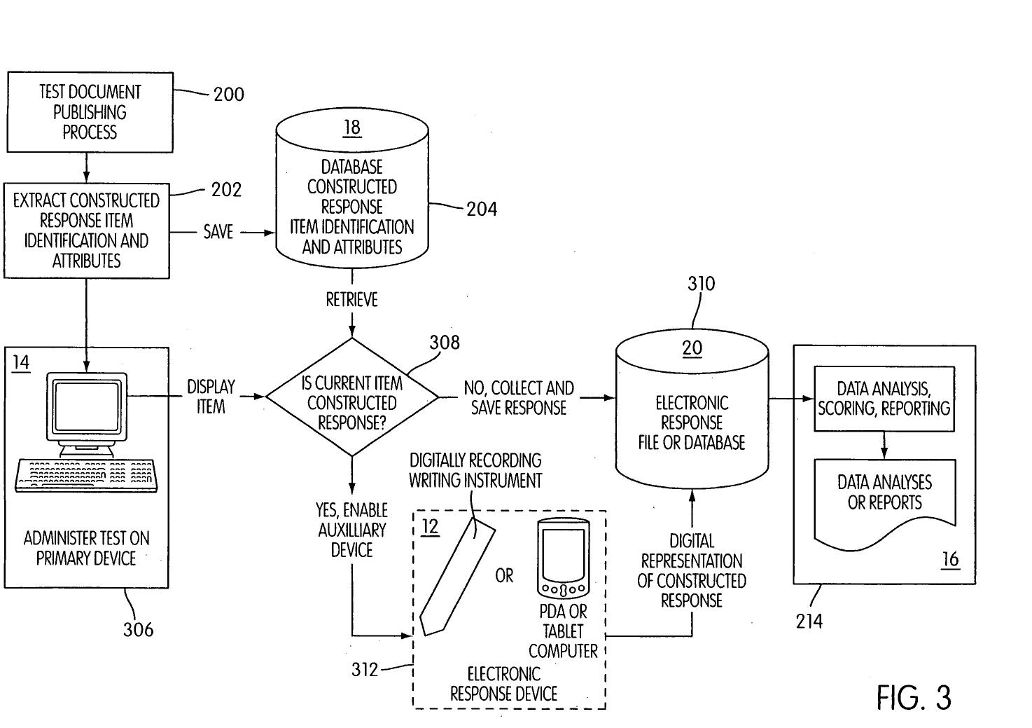

The operation of the system will now be explained with reference to FIG. 3. FIG. 3 is a flow diagram illustrating the system for and methodology of capturing and processing hand-written responses in the administration of educational assessments according to a second exemplary embodiment of the present invention. It should be noted that like components or steps as in FIG. 2 are denoted by like reference symbols.

The data file or database 18 of the response item mode attributes for each response item that is the current focus of input is verified, and the appropriate device (e.g., primary for selected response items or auxiliary for constructed response items) is enabled (steps 200-204) by the document processing and constructed response extraction systems. In step 306, the educational assessment is then administered by the item administration system, and the response items are presented. The response items may be presented electronically, as on a computer monitor, they may be presented on paper in printed form, or they may be presented aurally, by verbal or audio-recorded instructions. If it is determined, in step 308, that the response item is not a constructed response item that is best responded to with the auxiliary device, the primary device (e.g., keyboard or mouse device) is enabled. The respondent can respond to the response item using the primary device, and the response will be saved in a database or data file 20 (step 310). If it is determined, in step 308, that the response item is a constructed response item of a type that is not easily responded to with keyboard or mouse, the auxiliary device (e.g., digitally recording writing instrument device, a digital tablet or PDA with a stylus or touch screen input) is enabled (step 312).

As the respondent responds to the constructed response items using an auxiliary device with a display capability (e.g., digital tablet or PDA), a real time display of the response content may be displayed on the auxiliary device's display screen. A digital representation of the response is then stored in a data file or database 20 in step 310. When the digitally recording writing instrument device is used, the response content is visible on the stimulus document 14 as a written response. The pages of the stimulus document 14 used to collect the responses are either a generic page layout usable for any constructed response item, or specific pages corresponding to actual educational assessment items being administered. In the latter case, response item stimuli can be provided on the pages supplied to the respondent, which provides the same high density or quality as paper media. This eliminates the need to scroll or zoom display screens for viewing material. A digital representation of the response is then stored in the data file or database 20 (step 310) by the digitally recording writing instrument. Response content may also optionally be displayed in real time on the primary device's display, if available, regardless of type of auxiliary device that is used.

Referring to FIG. 3, the captured digital representation of the response is analyzed, scored, and reported in step 214 via the response analysis system 16. It will be appreciated by those skilled in the art that the recorded data can be processed or analyzed using various means.

For constructed responses, a human can read the original written response or the electronic image of the response and then assign a score or data category that is stored in a data file or database 20 for later analysis and reporting. For example, U.S. Pat. No. 5,672,060, the disclosure of which is incorporated herein by reference, describes a process by which a human can read an electronic image of a response and assign a score or data category that is stored in a data file or database for later analysis and reporting.

Alternatively, when the response consists of alphanumeric characters and/or punctuation, automated handwriting recognition can be applied to the electronic record of the constructed response to render the response into another form, such as ASCII text, that is then either scored or analyzed electronically, or scored or analyzed by a human scorer. The resultant score or analytic information can then be stored in a data file or database 20 for later analysis and reporting.

In a third exemplary embodiment of the present invention, the recording device 12 is a digitally recording writing instrument (primary device). The digitally recording writing instrument 12 can be used to respond to both constructed and selected response items administered in an assessment. The digitally recording writing instrument 12 can be provided with a unique serial identification number that can be recorded into a database or data file 20 to be used in identifying the respondent. The serial number can subsequently be used to verify the identity credentials presented by the respondent at the time of the administration of the assessment.

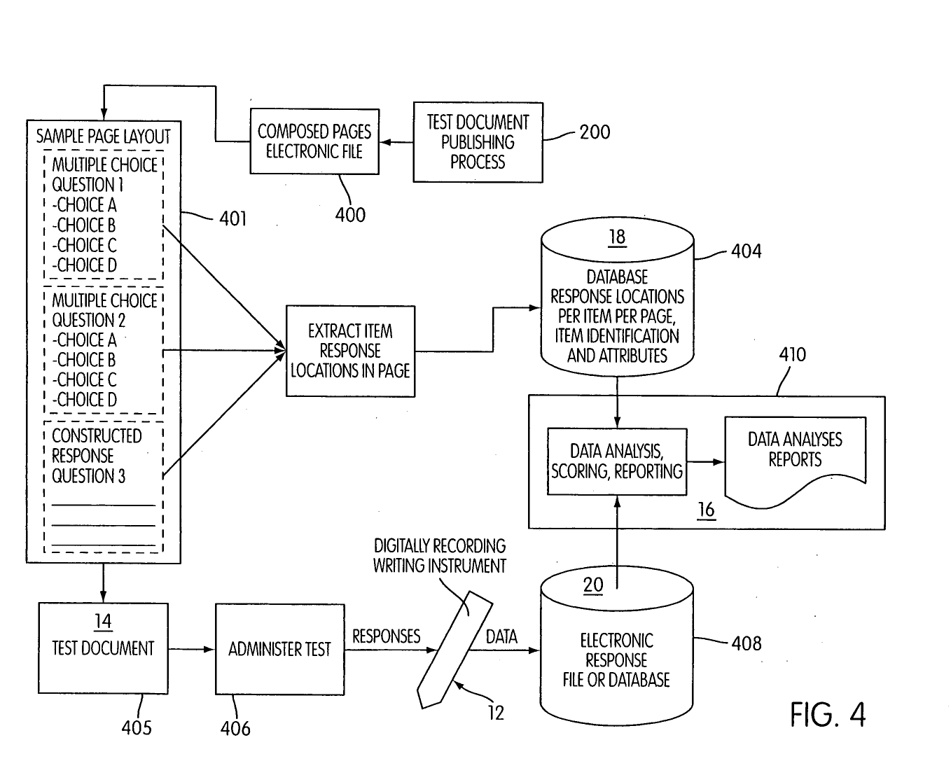

The operation of the system will now be explained with reference to FIG. 4. It should be noted that like components or steps as in FIG. 2 are denoted by like reference symbols. An assessment document 14 is processed in step 200 by the document processing system. A set of composed page electronic files defining the appearance of each printed page that is included in the assessment document 14 is produced (step 400) by a document production system.

For an administration using the digital recording writing instrument 12 and associated grid pattern developed by Anoto AB, as described above, each page is then electronically merged with an assigned underlying unique grid pattern as required by the digitally recording writing instrument in step 401. The electronically merged composed pages are used to print (step 405) the assessment document 14, which is administered to a respondent, in step 406.

The location of each response item response area on the page is stored in a database or data file 18 along with item attributes that are used to score or analyze the completed assessment in step 404. While these locations could be manually recorded and stored, in the preferred embodiment, the item location system in step 402 determines the locations based on appearance of the page as specified in the composed page electronic files.

The stimulus of each response item may be presented electronically as on a computer monitor, on document 14 in printed form, or aurally, by verbal or audio-recorded instructions. The response, however, is written on document 14 using digitally recording writing instrument 12.

During the administration of the assessment, the recording device 12 electronically captures hand-written strokes, stroke locations within a specific page, time stamp information, pressure and angle measurements of the digitally recording writing instrument, etc., as further described below. The captured information can be stored in a database or data file 20 (step 408). The information is then analyzed to extract data which may include the response items, information related to the identity of the respondent, information related to the administration of the assessment or survey, as well as other items. Once the data extraction process is complete, scoring or data analysis is performed on the extracted data (step 410) in the response analysis system 16.

Constructed Responses: When the response is a constructed response, all of the marks or strokes of the respondent are typically combined to provide an electronic image of the response. Similar to the first and second exemplary embodiments, a human scorer can read the original written response or the electronic image of the response and assign a score or data category, or alternatively, automated handwriting recognition can be applied to the constructed response.

However, the respondent may make mistakes and overwrite information to “correct” the response leaving the total reconstructed image difficult to read. In order to determine the intended response by the respondent, the time stamped information recorded with each stroke can advantageously be used. When the constructed response is scored by a human scorer viewing an electronic image of the constructed response, several means can be used to obtain an image that accurately reflects the respondent's intent.

One option is to provide an on-screen control for the human scorer to selectively specify one or more points in time (based on the time-stamped strokes) as delimiting any response-change events within the total time used by the respondent to make the entire response. The human scorer can heuristically adjust the delimiting times to resolve the final version of the response based on visual features and the response time-line.

It will be appreciated by those skilled in the art that other methods of changing constructed responses can be implemented in the present invention. For example, an erasure feature can be provided on the digitally recording writing instrument itself. Such feature electronically captures the location of the digitally recording writing instrument during the erasure operation. If a respondent makes a change to a previously made constructed response using an erasure feature on the digitally recording writing instrument, the resulting electronic image of the constructed response must have relevant prior pen strokes removed based on the erasure. This procedure should ensure that that the final electronic image accurately reflects the respondent's intent. Alternatively, when the constructed response is scored by a human scorer, an on-screen control can be provided to allow a human scorer to selectively view one or more of the time-delimited erasure event (based on the time-stamped strokes) response portions at the same time (e.g., a unique display color).

Selected responses: Selected responses can be captured using the recording device 12, e.g., digitally recording writing instrument or the like. A respondent can mark a designated response area to indicate their answer choice in a manner analogous to marking “bubbles” on an Optical Mark Read (OMR) bubble sheet. For assessments supported by an Anoto-style pen and paper, the “designated areas” for marking selected responses can be defined on an answer sheet or test book by specifying particular portions of the position coding pattern. The respondent marks the answer choice by placing strokes into or around a designated answer choice response area. If the respondent wishes to change a previously selected answer, several strategies can be used.

For a first strategy, the respondent can designate the preferred response through a hierarchical process: for instance the respondent can cross out an answer (e.g., draw an “X” across the selected answer), and then select another answer; to re-select a previously crossed out answer, the respondent can circle the crossed out answer.

By utilizing the time sequence information in the capture device, however, a preferred method can be used. When a respondent desires to change an answer, the respondent merely makes a mark on a different response selection. The last selection marked is then accepted as the desired response.

It will be appreciated by those skilled in the art that other methods of changing previously selected answers can be implemented in the present invention. For example, an erasure feature can be provided on the digitally recording writing instrument itself. Such feature electronically captures the location of the digitally recording writing instrument during the erasure operation. Accordingly, the answer choice to be de-selected is algorithmically determined, and the changes may be displayed in real-time or near real-time.

Signature: As described above, the recording device 12 captures hand-written data or information. The stroke pressure and angle measurements associated with a respondent's signature or other personal identifier can be electronically captured and stored in a database or data file 20. This information can subsequently be used to authenticate the respondent's identity by electronically comparing the stored information with a signature or other personal identifier supplied during the administration of an educational assessment. Further, stroke information can be compared to previously provided samples, and compared with each stroke captured during the administration of an assessment as an additional or alternative means to authenticate the respondent's identity. The recorded strokes can also be played back (e.g., forward, reverse, pause, skip, etc.) in a time ordered sequence for purposes including scoring, research, and usability testing.

Demographic Data: When needed to uniquely identify the respondent, demographic or other identifying data can be written on the assessment document 14 using a digital recording device 12, and the recorded strokes or marks can be analyzed to determine the unique identification of the respondent. Methods to identify the respondent can alternatively include the assignment of a particular recording device to a known respondent, having the respondent authenticated by entering information using a keyboard, mouse, or similar device, and other methods known to those practiced in the art.

The response analysis system 16 generates the reports that may include images of the responses with or without at least some portion of the information printed on the pages on which the responses were written. By incorporating information printed on the page, the image derived from the digitally recording writing instrument 12 can be recognized in the context of the assessment item.

The present invention provides a system for and methodology of capturing and processing hand-written responses by integrating known methods of capturing hand-writing into the administration of educational assessments. While this invention is primarily directed to educational assessments, it can be advantageously applied to other assessments, surveys, or other applications that typically capture of data from paper.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

While exemplary embodiments of the present invention have been described above, it should be understood that they have been presented by way of example only, and not limitation. Thus, the breadth and scope of the present invention should not be limited by the above described exemplary embodiment.

Obviously, numerous modifications and variations of the present invention are possible in light of the above teachings. It is therefore to be understood that the invention may be practiced otherwise than as specifically described herein.

What is claimed is:

1. A method of administering an educational assessment item requiring a hand-written response by a respondent, said method comprising:
presenting to the respondent a stimulus requesting a hand-written constructed response by the respondent;
permitting the respondent to form a handwritten constructed response on a writing surface using a writing instrument;
electronically recording the hand-written constructed response substantially simultaneously with the respondent's formation of the constructed response with the writing instrument to create recorded electronic data representative of the hand-written response; and
analyzing the recorded electronic data to evaluate the hand-written response to the stimulus.

2. The method of claim 1, wherein electronically recording the hand-written constructed response comprises electronically recording hand movements of the respondent as the respondent forms the hand-written constructed response with the writing instrument.

3. The method of claim 1, wherein electronically recording the hand-written constructed response comprises electronically recording positions of the writing instrument as the respondent forms the hand-written constructed response with the writing instrument.

4. The method of claim 3, wherein electronically recording hand movements comprises:
providing a position coding pattern on the writing surface; and
providing a sensor coupled to the writing instrument, the sensor being constructed and arranged to read the position coding pattern and to determine from the position coding pattern the position of the writing instrument on the writing surface.

5. The method of claim 1, wherein the hand-written constructed response includes one or more of letters, punctuation marks, numbers, drawings, graphic symbols and signs, music notation, grammatical operators, mathematical operators, or logic operators.

6. The method of claim 1, further comprising electronically recording the time spent by the respondent to form the hand-written constructed response to the stimulus, wherein said analyzing step further comprises evaluating the recorded time spent by the respondent to form the hand-written constructed response to the stimulus.

7. The method of claim 1, wherein electronically recording the hand-written constructed response comprises providing a digitally recording writing instrument to the respondent, said digitally recording writing instrument being constructed and arranged to permit the respondent to prepare a non-electronically recorded hand-written response to the stimulus on the writing surface, while electronically recording positions of the digitally recording writing instrument during the respondent's preparation of the response to create the electronic data representative of the respondent's response to the stimulus.

8. The method of claim 1, further comprising presenting to the respondent a stimulus requesting a hand-written selected response by the respondent;
permitting the respondent to form a handwritten selected response on a writing surface using a writing instrument; and
electronically recording the hand-written selected response.

9. The method of claim 7, further comprising recording identifying writing characteristics including at least one of stroke pressure and instrument angle measurements of the digitally recording writing instrument associated with a particular respondent's hand-writing, and subsequently using the identifying writing characteristics to confirm the identity of a respondent.

10. The method of claim 1, further comprising providing a procedure whereby the respondent can erase and revise portions of a hand-written constructed response by electronically displaying each portion of the electronic data that is delimited by an erasure event in a distinguishing manner.

11. A system for administering an educational assessment item requiring a hand-written response by a respondent, said system comprising:
a stimulus to be presented to a respondent, said stimulus requesting a hand-written constructed response by the respondent;
a writing instrument adapted to be used by the respondent to form the hand-written constructed response on a writing surface;
a recording device adapted to electronically record the hand-written constructed response substantially simultaneously with the respondent's formation of the constructed response with the writing instrument to create recorded electronic data representative of the hand-written response; and
a response analysis system adapted to facilitate the analysis of the recorded electronic data to evaluate the hand-written response to the stimulus.

12. The system of claim 11, wherein the hand-written constructed response comprises one or more of letters, punctuation marks, numbers, drawings, graphic symbols and signs, music notation, grammatical operators mathematical operators, or logic operators.

13. The system of claim 11, wherein said recording device is further adapted to electronically record the time spent by the respondent to form the hand-written constructed response, and wherein said response analysis system is further adapted to evaluate the recorded time spent by the respondent to complete the hand-written response to the stimulus.

14. The system of claim 11, wherein the recording device comprises a digitally recording writing instrument.

15. The system of claim 14, further comprising memory storage for storing the recorded electronic data, and wherein said digitally recording writing instrument communicates with said memory storage by at least one of (a) a wireless connection between said digitally recording writing instrument and said memory storage, (b) internal memory on said digitally recording writing instrument that is transferred by a complementary docking station in communication with said memory storage, and (c) a tethered communication link connecting said digitally recording writing instrument with said memory storage.

16. The system of claim 11, further comprising:
a document processing system constructed and arranged to extract information relating to one or more stimuli from electronic files and create an assessment document containing selected ones of the one or more stimuli;
a constructed response extraction system constructed and arranged to identify items requiring a constructed response; and
an item administration system constructed and arranged to administer the assessment document to one or more respondents.

17. The system of claim 11, wherein the response analysis system includes a human scorer.

18. The system of claim 11, wherein the response analysis system includes an automated handwriting recognition system.

19. A method of administering an educational assessment item requiring a hand-written response by a respondent, said method comprising:
presenting to the respondent a stimulus requesting a hand-written selected response by the respondent;
permitting the respondent to form a handwritten selected response at a designated location on a writing surface using a writing instrument;
electronically recording the location of the hand-written selected response substantially simultaneously with the respondent's formation of the selected response with the writing instrument to create recorded electronic data representative of the hand-written response; and
analyzing the recorded electronic data to evaluate the hand-written response to the stimulus.

20. The method of claim 19, wherein electronically recording location of the hand-written selected response comprises:
providing a position coding pattern on the writing surface and defining the designated areas by specifying particular portions of the position coding pattern;
providing a sensor coupled to the writing instrument, the sensor being constructed and arranged to read the position coding pattern and to determine from the position coding pattern the position of the writing instrument on the writing surface; and
determining the designated area in which the selected response is made from the particular portions of the position coding pattern read by the sensor.
